(19) United States
(12) Patent Application Publication
(10) Pub. No.: US 2006/0086831 A1
(43) Pub. Date: Apr. 27, 2006

(54) High pressure water sprayer

(75) Inventors: Rong-Feng Tsai, Hsinchu County (TW); Yi-Liang Shu, Hsinchu County (TW); Chen-Yang Lan, Hsinchu County (TW); Mu-Long Lin, Hsinchu County (TW); Wen-Chun Chang, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/129,343

(22) Filed: May 16, 2005

(30) Foreign Application Priority Data
Oct. 26, 2004 (TW) 93132353

(51) Int. Cl. B05B 1/14

(52) U.S. Cl. 239/553; 239/548

(57) ABSTRACT

The present invention provides a high-pressure water sprayer for fire extinguishment, including a body having a base and a fluid conduit connecting thereto, and at least two spray heads and fluid-guiding bars respectively corresponding thereto. The base is provided with at least two positioning slots for positioning the spray heads. Each of the positioning slots communicates with a main fluid passage within the fluid conduit via a branched fluid passage. A nozzle is formed at a lower end of the spray head, and an orifice is formed at an upper end of the spray head for the fluid-guiding bar to be disposed in a receiving space within the spray head. Then the receiving space communicates with the nozzle. A lower end of the fluid-guiding bar is provided with fluid-guiding grooves opposite to the nozzle. The spray heads are arranged in at least two different disposed angles. An appropriate spray angle can be obtained by adjusting the angle between the nozzle and the base. By means of designing different fluid-guiding grooves of the fluid-guiding bars cooperated with different-sized orifices of the nozzles to control the spray angle, droplet diameter and jet configurations, various spraying configurations including diversified mixed droplet diameter jets can be obtained. The present invention can use appropriate spray heads to generate liquid jets with an appropriate diameter and spray angle for respective fire-extinguished object.

### BACKGROUND OF THE INVENTION

1. Field of the Invention

The present invention relates to a water sprayer, and more particularly, to an improved high-pressure water sprayer that is capable of providing diversified liquid jets for fire extinguishment.

2. Description of the Related Art

The Montreal Protocol signed by the US and other major industrialized countries in the world in 1987 stipulates the production and consumption of ChloroFluoroCarbons (CFCs) and restricts its production, so as to protect the ozone in the stratosphere. Hence, in response to environmental protection, the Halon fire extinguishing systems are required to conduct a full-scale evaluation of the alternative Halon fire-extinguishing agents.

Recently, water mist has become a new topic in the effective fire extinguishment and environmental protection issue. Studies show that water mists at a diameter below 1000 μm have a good heat absorptive action, and can also deeply penetrate into the fire source through the entrainment effect and then extinguish deep fire. One gram of water mists, theoretically, can absorb 2.4 KJ of vaporization heat. As this saves a lot of water, water consumption is very little, and can also extinguish the majority of fires caused by Class A to Class C fuels. Hence, this becomes a good choice for the alternative halon products.

The construction of traditional high-pressure water sprayers is shown in FIG. 13, in which the high-pressure sprayer 90 is provided with a plurality of circumferentially and downwardly slanted evenly spaced orifices 91 of the nozzle. The construction of all the orifices 91 of the nozzle as circular rings is shown in FIG. 14 (each orifice 91 of the nozzle is at an angle of 18°), and the diameter of each orifice 91 of the nozzle generally lies between 0.1 mm and 0.6 mm. When water is compressed by a high-pressure pump and then conveyed to the high-pressure sprayer 90 via water pipes, the compressed water generates cone-shaped high-speed liquid jets through the orifices 91 of the high-pressure sprayer 90.

Although the diameter of the orifice 91 is extremely small so that the high-speed liquid jets contain water mists of high penetration power, a small spray angle, and a small diameter, after the high-speed liquid jets have come into high-speed friction and stirring with the air outside, there are still some shortcomings inherent in the traditional high-speed sprayer 90 as follows:
1. To produce fine spray, high pressure (approximately 100 kgf/cm²) is required to be applied by the high-pressure sprayer 90 to produce aerification;
2. As the diameter of the orifice 91 of the nozzle is extremely small, it is extremely not easy to further process the orifice of the nozzle;
3. Just because the diameter of the orifice 91 of the nozzle is extremely small, this also reduces water flow and the diameter of output pipes, thereby easily causing the orifices of the nozzle to block;
4. The great jet distance produced by high pressure, together with the minute orifices 91 of the nozzle, easily causes minute hollow-type water mists, thereby making it difficult to achieve effective fire extinguishment purposes;
5. The spraying configuration (such as spray diameter, spray angle, and jet distance) of the high-pressure sprayer 90 is dependent on the size and the position of the orifice 91 of the nozzle. Hence, it is difficult to adjust the jet configuration, so that this construction is not flexible enough and is unable to effectively adjust the jet configuration with reference to the actual fire conditions.

### SUMMARY OF THE INVENTION

It is a primary object of the present invention to provide a sprayer comprising a mixed spray base and fluid-guiding bars, and by means of a special design of fluid-guiding grooves of the fluid-guiding bars and a design of an angle of the base, the sprayer of the present invention can generate a mixed spray of liquid jets with a spray diameter smaller than 1000 μm; by means of different fluid-guiding bar designs, cooperated with different nozzles, the spray angle, the jet diameter, and the jet configuration can be adjusted to produce different liquid jet effects, so as to accommodate to different fire extinguishing purposes.

The principles for improving the high-pressure sprayer are as follows: the flow of the sprayer are directly proportional to the square of the diameter of the nozzle (dL²) and the square root of pressure (√p). In other words, the greater the water flow, the greater the amount of heat absorption per unit space. Keep the water flow and the operating pressure constant, to obtain the diameter and the Sauter Mean Diameter (SMD) of the orifice of the nozzle of the sprayer. Hence, the present invention provides a sprayer with fluid-guiding bars disposed in its nozzle, and by adjusting the nozzle and the specially designed fluid-guiding bars, the radial velocity component of the minute water mists is increased, such that the spray angle and the SMD appropriate for spraying water can be obtained, and the operating pressure of the sprayer is also reduced.

To achieve the aforementioned objects of the present invention, the water sprayer of the present invention comprises: a body having a base and a fluid conduit connecting thereto; and at least two spray heads and fluid-guiding bars respectively corresponding thereto. The base is provided with at least two positioning slots for positioning the spray heads. Each of the positioning slots communicates with a main fluid passage within the fluid conduit via a branched fluid passage. A nozzle is formed at a lower end of the spray head, and an orifice is formed at an upper end of the spray head for the fluid-guiding bars to be disposed in a receiving space within the spray head. The receiving space then communicates with the nozzle. Moreover, a lower end of the fluid-guiding bar is provided with fluid-guiding grooves opposite to the nozzle.

The spray heads of the sprayer are arranged in at least two different disposed angles.

When the spray heads are arranged in two different disposed angles, they are arranged into an inner ring region and an outer ring region, and moreover, the disposed angle of the spray head in the outer ring region is greater than the disposed angle of the spray head in the inner ring region.

When the spray heads are arranged in three different disposed angles, they are arranged into a central ring region, an inner ring region, and an outer ring region, and moreover, the disposed angle of the spray head in the outer ring region is greater than the disposed angle of the spray head in the inner ring region, and the disposed angle of the spray head in the inner ring region is greater than the disposed angle of the spray head in the central ring region.

A seal ring is disposed between the spray head and the positioning slot.

The spray head and the positioning slot are fastened together by means of a screw connection.

The fluid-guiding grooves of the fluid-guiding bars are constructed by a main fluid-guiding groove and two branched fluid-guiding grooves perpendicularly connected to two sides of the main fluid-guiding groove arranged in an opposite direction.

The fluid-guiding grooves of the fluid-guiding bars are straightly arranged.

The fluid-guiding grooves of the fluid-guiding bars are constructed by disposing two fluid-guiding grooves in an opposite direction and separating them by a certain distance.

The fluid-guiding grooves of the fluid-guiding bars are radially arranged.

The structure and technical means adopted by the present invention to achieve the above objects or characteristics can be best understood by referring to the following detailed description of the preferred embodiments and the accompanying drawings. However, it is to be understood that the scope of the present invention is not limited or narrowed by the following drawings and embodiments. To the contrary, the scope of the appended claims therefore should be accorded the broadest interpretation so as to encompass all such modifications and similar arrangements and procedures.

The operating pressure of the spray head lies between 30 bar and 150 bar.

The SMD of the liquid jet generated by the spray head is smaller than 1000 μm.

Each of the aforementioned spray angles can provide space for one to twelve spray heads.

The combinations of the spray heads by means of designing different fluid-guiding bars cooperated with different-sized orifices of nozzles can produce various liquid jets with different droplet diameters and spray angles. As such, mixed liquid jets comprising large and small droplet diameters can be generated.

### BRIEF DESCIPTION OF THE DRAWINGS

The structure and technical means adopted by the present invention to achieve the above and other objects can be best understood by referring to the following detailed description of preferred embodiments and accompanying drawings, wherein

FIG. 1 shows a vertical cross-sectional view showing the construction of the water sprayer of the present invention.

FIG. 2 shows a perspective view of the fluid-guiding bar of the water sprayer of the present invention.

FIG. 3 shows a plane view of the fluid-guiding grooves at a lower end of the fluid-guiding bar of the water sprayer of the present invention.

FIG. 4 is a bottom view of the sprayer of the present invention, showing a plurality of spray heads are arranged in three different disposed angles.

FIG. 5 is a bottom view of the sprayer in another embodiment of the present invention, showing a plurality of spray heads are arranged in two different disposed angles.

FIG. 6 is an illustration of water mists comprising both small and large droplet diameters according to different arrangements of spray heads and fluid-guiding bars of the sprayer as shown in FIG. 5.

FIG. 7 is another embodiment of FIG. 6 according to the present invention.

FIG. 8 is another embodiment of FIG. 6 according to the present invention.

FIG. 9 is another embodiment of the fluid-guiding bar as shown in FIG. 2 of the present invention.

FIG. 10 is another embodiment of the fluid-guiding bar as shown in FIG. 2 of the present invention.

FIG. 11 is another embodiment of the fluid-guiding bar as shown in FIG. 2 of the present invention.

FIG. 12 is an illustration of water mists generated by a water sprayer as shown in FIG. 1 of the present invention.

FIG. 13 is an illustration of water mists generated by a traditional high-pressure water sprayer.

FIG. 14 is a bottom view of the traditional high-pressure water sprayer.

### DETAILED DESCRIPTION OF THE PREFERRED EMBODIMENTS

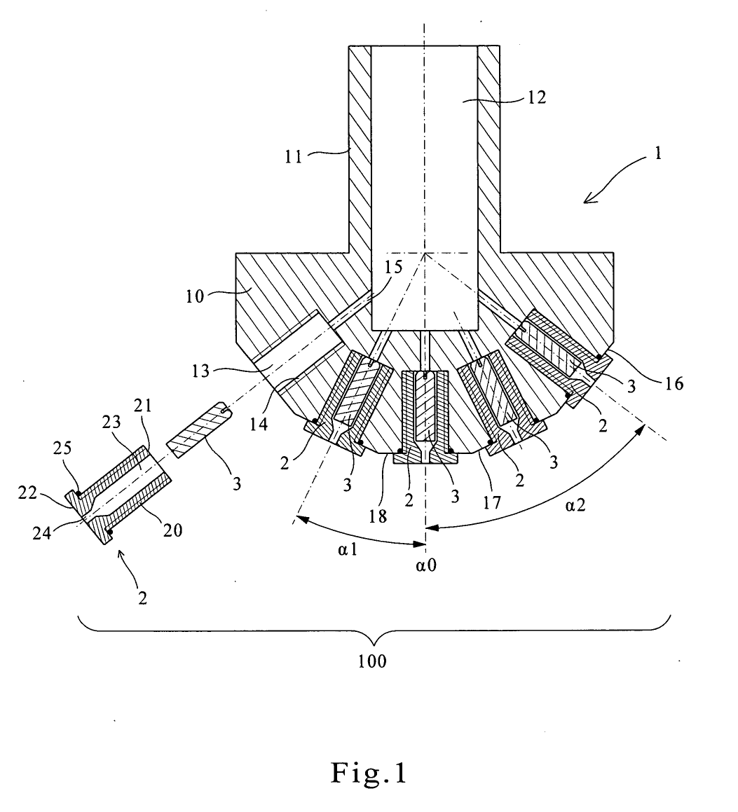

Please refer to FIG. 1, which shows a vertical cross-sectional view of the sprayer 100 of the present invention. The sprayer 100 of the present invention comprises: a body 1 having a base 10 and a fluid conduit 11 connecting thereto, a plurality of spray heads 2 and fluid-guiding bars 3 corresponding to the spray heads 2 respectively.

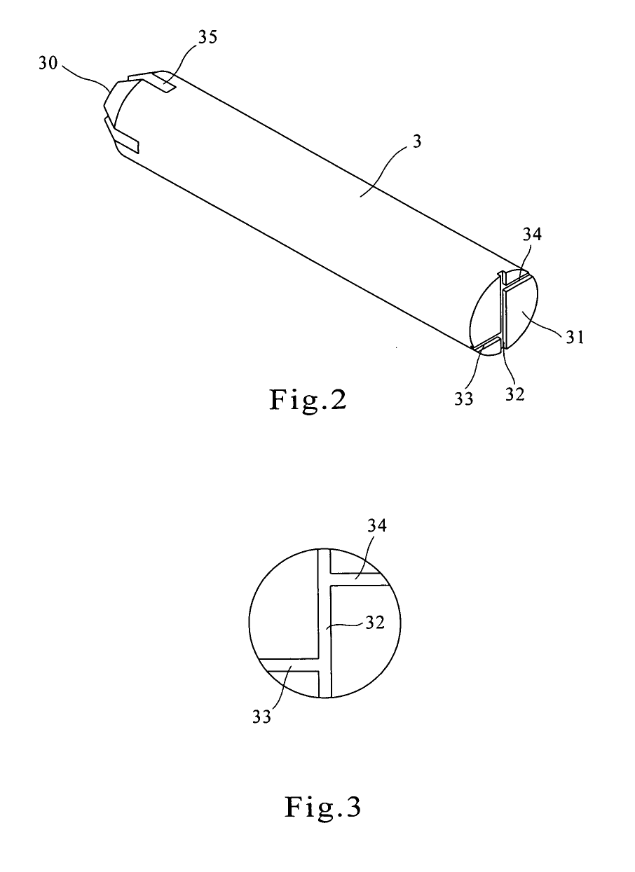

The base 10 is provided with a plurality of positioning slots 13 corresponding to the spray heads 2 respectively. The inner walls of each of the positioning slots 13 are provided with a female thread portion 14, and each positioning slot 13 communicates with a main fluid passage 12 within the fluid conduit 11 via a branched fluid passage 15; a nozzle 24 is formed at a lower end 22 of the spray head 2, and an orifice is formed at an upper end 21 of the spray head 2 and communicates with a receiving space 23 within the spray head 2. The receiving space 23 then communicates with the nozzle 24. Moreover, the diameter of the nozzle 24 is smaller than the diameter of the receiving space 23, and a male thread portion 20 is formed on the external circumferential surface of the spray head 2; a lower side 31 of the fluid-guiding bar 3 is provided with a fluid-guiding groove comprising a main fluid-guiding groove 32 and branched fluid-guiding grooves 33, 34 perpendicularly connected to two sides of the main fluid-guiding groove 32 arranged in the opposite direction. Then the fluid-guiding groove is opposite to the nozzle 24, and an upper end 30 of the fluid-guiding bar 3 is provided with a cross-shaped groove 35. Please refer to FIG. 2 and FIG. 3 for the construction of the fluid-guiding bar 3.

To assemble them, it is first to dispose the fluid-guiding bar 3 into the receiving space 23 of the spray head 2, so that the fluid-guiding groove of the spray head 2 is opposite to the nozzle 24. Then the spray head 2 is locked into the female thread portion 14 of the positioning slot 13 via the male thread portion 20, such that the spray head 2 is fastened on the base 10. To achieve the sealing effect of the screw connection of the spray head 2 and the base 10, a seal ring 25 is disposed therein.

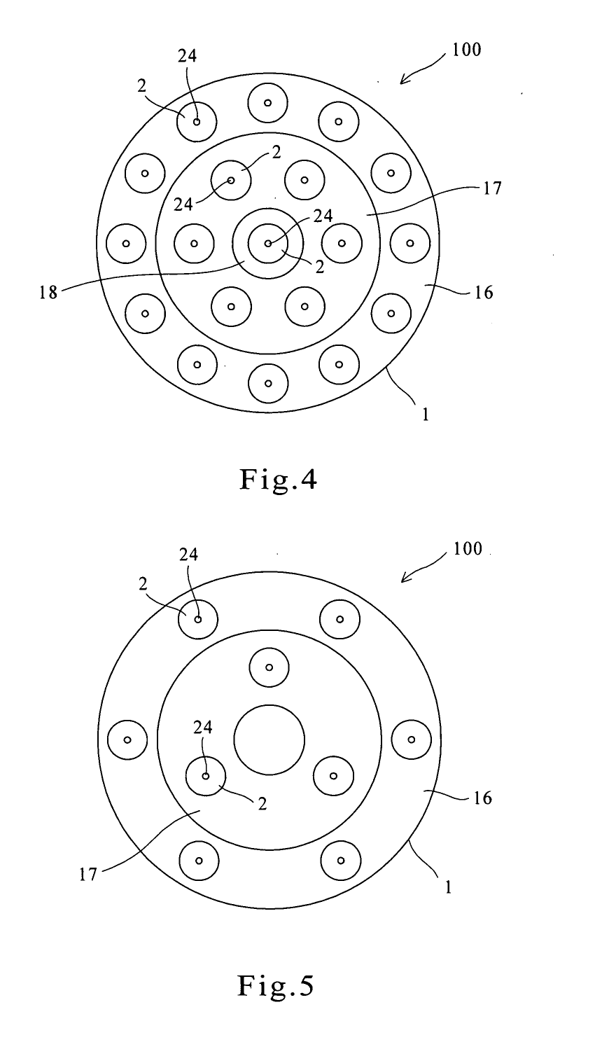

Please refer to FIG. 1 and FIG. 4. The vertical central axis of the sprayer 100 is provided with a post-assembly spray head 2, which is disposed in a central region 18. In other words, the central region 18 is provided with only one spray head 2. The angle of the spray head 2 coaxial to the central axis is 0 and is marked as α0; the periphery of the spray head 2 adjacently disposed in the central region 18 is provided with six equally spaced spray heads 2, which are disposed in the inner ring region 17. The angle of each spray head 2 between the inner ring region 17 and the central axis is 35′, and is marked as α1; the periphery of the spray head 2 adjacently disposed in the inner ring region 17 is provided with twelve equally spaced spray heads 2, which are disposed in the outer ring region 16. The angle of each spray head 2 between the outer ring region 16 and the central axis is 70°, and is marked as α2. In other words, the spray head 2 of the sprayer 100 is arranged in three different angles, that is α0, α1, and α2, and moreover, α0 is smaller than α1, which is smaller than α2.

The fluid conduit 11 of said sprayer 100 connects to the hose, and when water is compressed by a high-pressure pump and then conveyed to the high-pressure sprayer 100, the high-pressure water then enters different branched fluid passages 15 via the main fluid passage 12 to reach the spray head 2, and via receiving spaces 23 within the spray head 2 and the minute cracks of the fluid-guiding bar 3, connects to the nozzle 24 via the fluid-guiding groove of the fluid-guiding bar 3, and then finally the high-speed liquid jets are generated through different nozzles 24. The upper side 30 of the fluid-guiding bar 3 is provided with a cross-shaped groove 35, so as to increase the water flow into the spray head 2.

The high-speed liquid jets generated from the nozzle 24 contain water mists of high penetration, after the high-speed liquid jets have come into high-speed friction and stirring with the air outside, and by means of the fluid-guiding groove of the fluid-guiding bar 3, the radial velocity component of water mists can be increased, such that a suitable spray angle can be obtained, and the SMD of the liquid jets can become smaller than 1,000 μm, and moreover, the operating pressure of the sprayer 100 can lie between 30 bar and 150 bar.

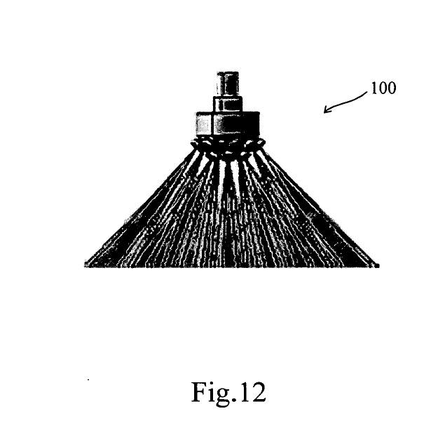

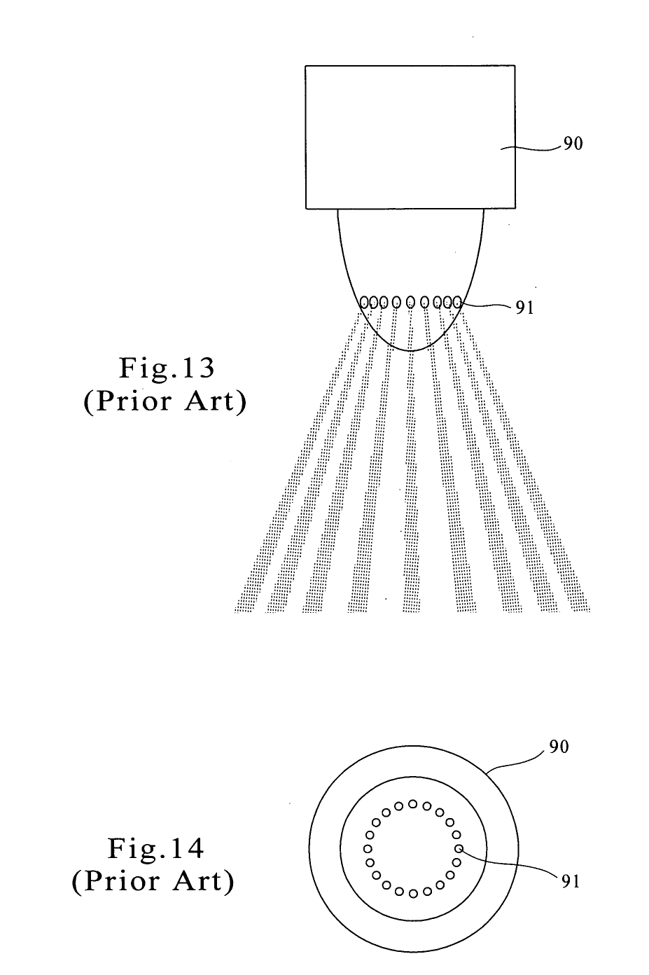

The principles of the design of the high-pressure water sprayer are that the water flow of the sprayer and the square root of pressure (√p) are directly proportional to the square of the diameter of the nozzle (dL²). In other words, the greater the water flow, the greater the amount of heat absorption per unit space. Keep the flow and the pressure constant, to obtain the diameter and the Sauter Mean Diameter (SMD) of the orifice of the nozzle of the sprayer. Theoretically, the interior of water mists is closer to the heat source or fire source, so that a higher liquid flux is required to accelerate its heat absorption rate, whereas the liquid flux of the exterior of water mists far away from the fire plume can be decreased to increase their protective area. Hence, the plurality of spray heads 2 of the sprayer 100 are arranged in three different angles, that is, α0, α1, and α2, according to FIG. 1, wherein α0 and α1 can increase the liquid flow inside the water mists, and together with the water mists at a large angle of α2, all the liquid jets generated through the spray head 2 generate deep and wide solid-type water mists, and then inside the three-dimensional jet region, deep and wide protective bands and effective spray areas are thus generated. Please refer this to FIG. 12.

According to FIG. 1 and FIG. 4, the spray heads 2 of the water sprayer 100 can be changed and arranged into the example as shown in FIG. 5. The embodiment as shown in FIG. 5 is different from FIG. 4 as follows: the spray heads 2 of the sprayer 100 are arranged only in the inner ring region 17 and the outer ring region 16, wherein the inner ring region 17 is provided with three equally spaced spray heads 2, whereas the outer ring region 16 is provided with six equally spaced spray heads 2. In other words, the spray heads 2 are arranged on the inner ring region and the outer ring region, so that two different disposed angles are formed; moreover, the disposed angle (that is α2 in FIG. 1) of the spray head 2 of the outer ring region is greater than the disposed angle (that is α1 in FIG. 1) of the spray head 2 of the inner ring region.

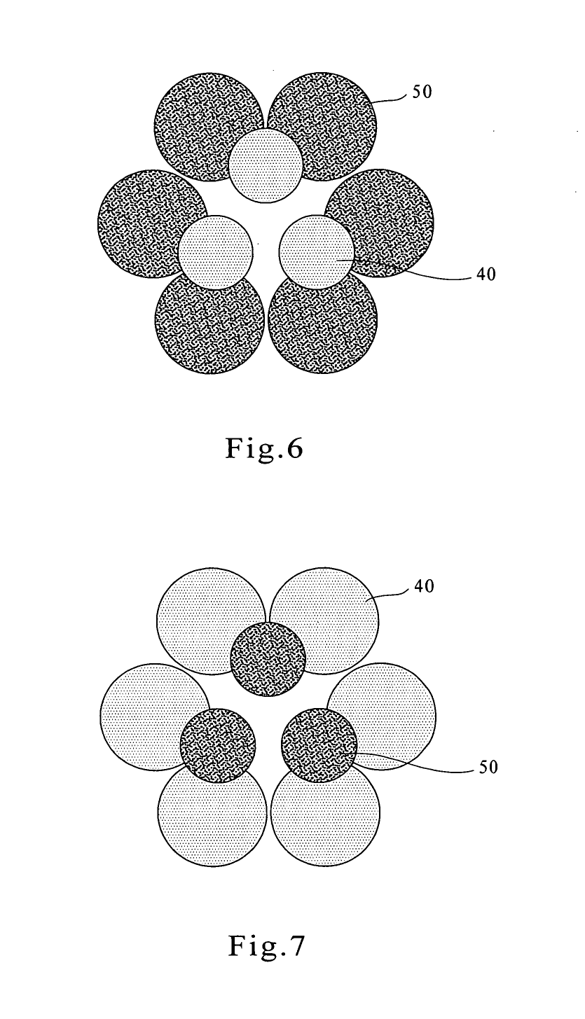

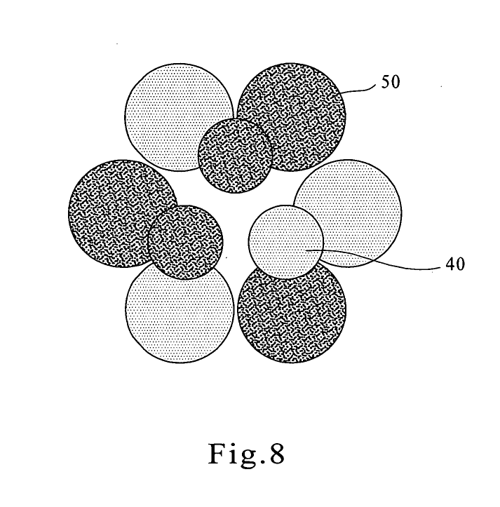

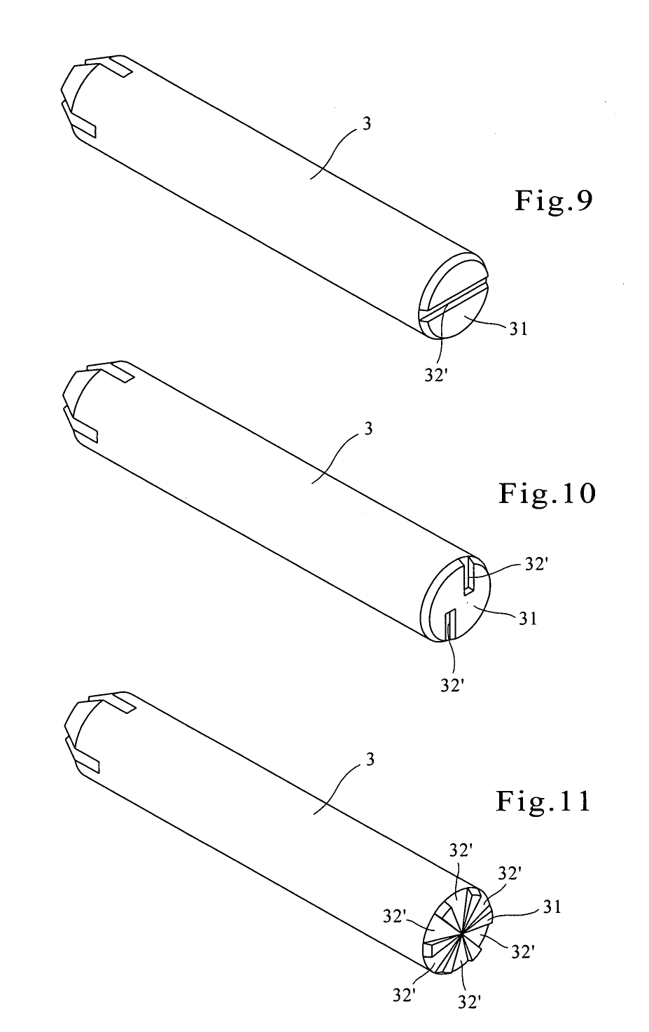

As the effect of the fluid-guiding bar 3 on the liquid jet properties is extremely great, undeniably different designs will produce different spray effects. The fluid-guiding groove 32 as shown in FIG. 9 is straightly disposed on the lower side 31 of the fluid-guiding bar 3; two fluid-guiding grooves 32′ as shown in FIG. 10 are oppositely disposed on the lower side 31 of the fluid-guiding bar 3 and separated by a certain distance; a plurality of the fluid-guiding grooves 32′ as shown in FIG. 11 are radially disposed on the lower side 31 of the fluid-guiding bar 3. By means of different configuration designs of the fluid-guiding grooves 32 (32′), together with nozzles 12 in different jet angles (α0, α1, and α2) and different diameters, different spray angles, jet diameters, and jet configuration (hollow-type or solid type) are obtained. In other words, as shown in FIG. 6 (please follow FIG. 5), the spray head 2 comprising a jet angle of α1 disposed in the inner ring region 17 can cooperate with a different diameter of the fluid-guiding grooves and the nozzle 24 of the fluid-guiding bars 3 in the outer ring region, such that the diameter (40) of the water mists produced is small, which is smaller than the large diameter (50) of the water mists produced by the outer ring region 16; on the contrary, as shown in FIG. 7, for the spray head 2 comprising a jet angle of α2 disposed in the outer ring region 16, the diameter (40) of the water mists produced is small, which is smaller than the large diameter (50) of the water mists produced by the inner ring region 17. According to the embodiments of FIG. 6 and FIG. 7, it is possible to further arrange a plurality of spray heads 2 comprising a jet angle of α2 in the outer ring region 16 into a smaller diameter (40) and a larger diameter (50), and then together with a plurality of spray heads 2 comprising a spray angle of α1 in the inner ring region 17, a smaller diameter (40) and a larger diameter (50) are produced. Please refer this to FIG. 8. Likewise, the plurality of spray heads 2 arranged in FIG. 4 can also generate a jet configuration comprising of both a small diameter (40) and a large diameter (50) as shown in FIG. 6 to FIG. 8. By means of the above-mentioned different spray combinations, different fire sources are extinguished to achieve diversified fire extinguishing purposes.

The advantage of the present invention is characterized in that the spray heads of different nozzle diameters and the fluid-guiding bars designed by different fluid-guiding grooves are arranged in diversified spray combinations, to produce water mists of different diameters or same diameters.

Conditions such as the size of the nozzle diameter of spray heads, the disposed angles of spray heads in different regions, the number of spray heads arranged, the configuration of the fluid-guiding grooves of fluid-guiding bars, and even the depth of the fluid-guiding grooves, or whether the plurality of spray heads are arranged in the central ring region or the outer ring region, the fact that the spray heads can be arranged in four different types of angles, or that the spray heads are only arranged in the outer ring region or the inner ring region and even the central ring region, etc. shall not be limited in the present invention, but can be arranged in diversified designs, so as to display diversified combinations and produce different liquid jet shapes and spray angles, for respective fire extinguishments purposes specially designed for different locations.

While the invention has been described by way of examples and in terms of preferred embodiments, it is to be understood that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures.

What is claimed is:

1. A water sprayer, comprising:
a body having a base and a fluid conduit connecting thereto, said base provided with at least two positioning slots, each of said positioning slots communicating with a main fluid passage within said fluid conduit via a branched fluid passage;
at least two fluid-guiding bars, each of said fluid-guiding bars provided with fluid-guiding grooves on a lower end thereof;
at least two spray heads, each of said spray heads fixed on one of said positioning slots of said base respectively; wherein a nozzle is formed at a lower end of said spray head, and an orifice is formed at an upper end of said spray head for said fluid-guiding bar to be disposed in a receiving space within said spray head, and said receiving space of said spray head communicates with said nozzle, and said fluid-guiding grooves of said fluid-guiding bars are opposite to said nozzle.

2. The water sprayer as claimed in claim 1, wherein said spray heads of said sprayer are arranged in at least two different disposed angles.

3. The water sprayer as claimed in claim 2, wherein said spray heads are arranged in an inner ring region and an outer ring region, and the disposed angle of said outer ring region is greater than the disposed angle of said inner ring region.

4. The water sprayer as claimed in claim 2, wherein said spray heads are arranged in a central ring region and an inner ring region, and the disposed angle of said inner ring region is greater than the disposed angle of said central ring region.

5. The water sprayer as claimed in claim 2, wherein said spray heads are arranged in a central ring region and an outer ring region, and the disposed angle of said outer ring region is greater than the disposed angle of said central ring region.

6. The water sprayer as claimed in claim 2, wherein said spray heads are arranged in a central ring region, an inner ring region, and an outer ring region, and the disposed angle of said outer ring region is greater than the disposed angle of said inner ring region, which is larger than the disposed angle of said central ring region.

7. The water sprayer as claimed in claim 1, wherein a seal ring is disposed between said spray heads and said positioning slots.

8. The water sprayer as claimed in claim 1, wherein said spray heads and said positioning slots are fastened together by means of screw connection.

9. The water sprayer as claimed in claim 1, wherein said fluid-guiding grooves of said fluid-guiding bars are constructed by a main fluid-guiding groove and two branched fluid-guiding grooves perpendicularly connected to two sides of said main fluid-guiding groove arranged in an opposite direction.

10. The water sprayer as claimed in claim 1, wherein said fluid-guiding grooves of said fluid-guiding bars are straightly arranged.

11. The water sprayer as claimed in claim 1, wherein said fluid-guiding grooves of said fluid-guiding bars are constructed by disposing two fluid-guiding grooves in an opposite direction and separating from each other by a certain distance.

12. The water sprayer as claimed in claim 1, wherein said fluid-guiding grooves of said fluid-guiding bars are radially arranged.

13. The water sprayer as claimed in claim 1, wherein an operating pressure of said spray head lies between 30 and 150 bar.

14. The water sprayer as claimed in claim 1, wherein a Sauter Mean Diameter (SMD) of liquid jet generated by said spray head is smaller than 1000 μm.

15. The water sprayer as claimed in claim 2, wherein one to twelve spray heads are provided in each said spray angle

16. The water sprayer as claimed in claim 1, wherein nozzles and fluid-guiding bars of different droplet diameters and spray angles are arranged to produce different combinations of liquid jet shapes and spray angles, and producing mixed liquid jets simultaneously comprising both large and small droplet diameters for respective fire-extinguished object specially designed for different locations.
